(19) United States
(12) Patent Application Publication
(10) Pub. No.: US 2026/0365808 A1
(43) Pub. Date: Nov. 19, 2026

(54) HARD COAT FILM AND METHOD FOR PRODUCTION THEREOF, AND DISPLAY

(71) Applicant: KANEKA CORPORATION, Osaka (JP)

(72) Inventor: Yusuke Taguchi, Osaka (JP)

(73) Assignee: KANEKA CORPORATION, Osaka (JP)

(21) Appl. No.: 19/299,043

(22) Filed: Aug. 13, 2025

Related U.S. Application Data
(63) Continuation of application No. PCT/JP2024/004804, filed on Feb. 13, 2024.

(30) Foreign Application Priority Data
Feb. 15, 2023 (JP) 2023-021988

(51) Int. Cl. C08J 7/046; C08J 5/18; G02B 1/14; G02B 1/18

(52) U.S. Cl. CPC C08J 7/046; C08J 5/18; G02B 1/14; G02B 1/18; C08J 2333/24; C08J 2433/12; C08J 2483/04

(57) ABSTRACT

A hard coating film including a transparent resin film having a first principal surface and a second principal surface, and a hard coat layer disposed on the second principal surface of the transparent resin film is disclosed. The transparent resin film has a thickness of 26 μm or more and contains a polyimide-based resin and a solvent-soluble resin other than the polyimide-based resin. No hard coat layer is provided on the first principal surface of the transparent resin film. An arithmetic mean roughness Sa of the first principal surface of the transparent resin film is 1 nm or less. A maximum height Sz of the first principal surface of the transparent resin film may be 70 nm or less.

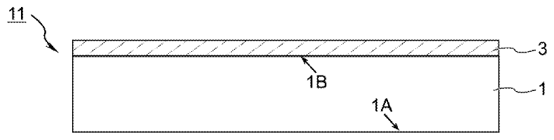

### TECHNICAL FIELD

One or more embodiments of the present invention relate to a hard coat film, a method for producing the same, and a display including the hard coat film.

### BACKGROUND

A film containing a transparent polyimide is superior in mechanical strength, and is expected to be applied as a cover window of a display. Patent Document 1 proposes to apply a hard coat film having a hard coat layer on a surface of a transparent polyimide film to a cover window.

### PATENT DOCUMENT

Patent Document 1: JP 2019-217647 A

Polyimide has a high refractive index, and thus has a large amount of light reflection (a high reflectance) due to a difference in refractive index at an air interface or an interface with another member, resulting in a low total light transmittance. Therefore, use of polyimide as a cover window material may cause a decrease in the luminance of a display. In addition, to use a transparent polyimide film as a cover window material, it is necessary to increase the thickness. However, when a transparent polyimide film having a large thickness is visually recognized from an oblique direction, the entire film plane is visually recognized as whitish, and variation in density of whiteness is visually recognized as unevenness (this phenomenon is hereinafter referred to as “whitening unevenness”), and visibility of a display may be deteriorated.

In view of the above, one or more embodiments of the present invention are to provide a hard coat film having a large thickness and being superior in mechanical strength, high in transparency, and difficult to be visually recognized with whitening unevenness.

### SUMMARY

The hard coat film of one or more embodiments of the present invention includes a transparent resin film having a first principal surface and a second principal surface, and a hard coat layer disposed on the second principal surface of the transparent resin film. The transparent resin film has a thickness of 26 μm or more and contains a polyimide-based resin and a solvent-soluble resin other than the polyimide-based resin. No hard coat layer is provided on the first principal surface of the transparent resin film. The arithmetic mean roughness Sa of the first principal surface of the transparent resin film is 1 nm or less. The maximum height Sz of the first principal surface of the transparent resin film may be 70 nm or less.

In the transparent resin film, the arithmetic mean roughness Sa of the second principal surface may be larger than the arithmetic mean roughness Sa of the first principal surface, and the maximum height Sz of the second principal surface may be larger than the maximum height Sz of the first principal surface. The arithmetic mean roughness Sa of the second principal surface of the transparent resin film may be 1.5 nm or more.

The transparent resin film may be a stretched film. As the solvent-soluble resin contained in the transparent resin film, an acryl-based resin is preferable, and of these resins, a resin containing methyl methacrylate as a main component is preferable. The polyimide-based resin contained in the transparent resin film is a polyimide or a polyamideimide, and the polyimide-based resin includes a structure derived from a tetracarboxylic dianhydride and a structure derived from a diamine. The polyimide-based resin may be one in which a fluorine-containing aromatic tetracarboxylic dianhydride and an alicyclic tetracarboxylic dianhydride are contained as the tetracarboxylic dianhydride, and a fluorine-containing diamine is contained as the diamine.

Examples of the material of the hard coat layer include an acryl-based hard coat material and a siloxane-based hard coat material. The thickness of the hard coat layer may be 1 to 50 μm.

The transparent resin film can be produced by applying a resin solution in which a polyimide-based resin and a solvent-soluble resin are dissolved in a solvent onto a support, and heating the solution on the support to dry and remove the solvent.

The surface of the support to which the resin solution is applied may have an arithmetic mean roughness Sa of0.5 nm or more, and may have a maximum height Sz of 10 nm or more. The support may be a plastic film.

A hard coat film is obtained by peeling off the transparent resin film from the support and forming a hard coat layer on one principal surface of the transparent resin film. In one or more embodiments, a surface of the transparent resin film on which the transparent resin film is peeled off from the support is taken as a second principal surface, and a hard coat layer is formed on this surface.

The hard coat film of one or more embodiments of the present invention is superior in mechanical strength because the transparent resin film has a large thickness. In addition, since the hard coat film has high transparency and whitening unevenness thereof is hardly visually recognized, the hard coat film is suitably used as a cover window material of a display.

### BRIEF DESCRIPTION OF THE DRAWING

The Figure is a sectional view of a hard coat film of one or more embodiments.

### DETAILED DESCRIPTION

The Figure is a sectional view of a hard coat film according to one or more embodiments of the present invention. The hard coat film 11 has a hard coat layer 3 on a transparent resin film 1. The transparent resin film has a first principal surface 1A and a second principal surface 1B, and the hard coat layer 3 is formed on the second principal surface 1B. The hard coat film 11 has the hard coat layer only on the second principal surface 1B of the transparent resin film 1, and no hard coat layer is provided on the first principal surface 1A of the transparent resin film 1.

### [Transparent Resin Film]

The transparent resin film 1 is a base material that serves as a base in forming the hard coat layer 3. The transparent resin film 1 has a thickness of 26 μm or more, and the arithmetic mean roughness Sa of the first principal surface 1A (the surface on the side on which the hard coat layer 3 is not provided) of the transparent resin film 1 is 1 nm or less.

The transparent resin film 1 is a blended resin film containing one or more polyimide-based resins selected from the group consisting of a polyimide and a polyamideimide, and a solvent-soluble resin other than the polyimide-based resins (hereinafter sometimes referred to as “OTHER resin”). When the transparent resin film 1 contains a polyimide-based resins and OTHER resin, transparency tends to be improved.

### <Polyimide-Based Resin>

The polyimide is obtained by cyclodehydrating a polyamic acid obtained by a reaction of a tetracarboxylic acid dianhydride (hereinafter, it may be referred to as “acid dianhydride”) with a diamine. The polyamideimide is obtained by replacing a part of the tetracarboxylic dianhydride of the polyimide with a dicarboxylic acid derivative such as dicarboxylic acid dichloride. As the polyimide-based resin, a polyimide and a polyamideimide may be used in combination. From the viewpoint of compatibility and the like with the OTHER resin, a polyimide may be preferable as the polyimide-based resin.

### (Tetracarboxylic Dianhydride)

The polyimide-based resin used in one or more embodiments of the present invention may contain an alicyclic tetracarboxylic dianhydride as an acid dianhydride component. Due to the fact that the acid dianhydride component has an alicyclic structure, the compatibility between the polyimide-based resin and the OTHER resin such as an acryl-based resin tends to be improved. The alicyclic tetracarboxylic dianhydride is only required to have at least one alicyclic structure, and may have both an alicyclic ring and an aromatic ring in one molecule. The alicyclic ring may be polycyclic, or may have a spiro structure.

Examples of the alicyclic tetracarboxylic dianhydride include 1,2,3,4-cyclobutanetetracarboxylic dianhydride, 1,2,3,4-cyclopentanetetracarboxylic dianhydride, 1,3-dimethylcyclobutane-1,2,3,4-tetracarboxylic dianhydride, 1,2,3,4-tetramethyl-1,2,3,4-cyclobutanetetracarboxylic dianhydride, 1,2,4,5-cyclohexanetetracarboxylic dianhydride, 1,2,3,4-butanetetracarboxylic dianhydride, meso-butane-1,2,3,4-tetracarboxylic dianhydride, 1,1′-bicyclohexane-3,3′,4,4′ tetracarboxylic-3,4:3′,4′-dianhydride, norbornane-2-spiro-α-cyclopentanone-α′-spiro-2″-norbornane-5,5″,6,6″-tetracarboxylic dianhydride, 2,2′-binorbomane-5,5′,6,6′ tetracarboxylic dianhydride, 3-(carboxymethyl)-1,2,4-cyclopentanetricarboxylic 1,4:2,3-dianhydride, bicyclo[2.2.2]octa-7-ene-2,3,5,6-tetracarboxylic dianhydride, 4-(2,5-dioxotetrahydrofuran-3-yl)-1,2,3,4-tetrahydronaphthalene-1,2-dicarboxylic anhydride, cyclohexane-1,4-diylbis(methylene)bis(1,3-dioxo-1,3-dihydroisobenzofuran-5-carboxylate), 5-(2,5-dioxotetrahydrofuryl)-3-methyl-3-cyclohexene-1,2-dicarboxylic anhydride, 5,5′-[cyclohexylidenebis(4,1-phenyleneoxy)]bis-1,3-isobenzofurandione, 5-isobenzofurancarboxylic acid,1,3-dihydro-1,3-dioxo-,5,5′-[1,4-cyclohexanediylbis(methylene)]ester, bicyclo[2.2.1]heptane-2,3,5,6-tetracarboxylic dianhydride, bicyclo[2.2.2]octane-2,3,5,6-tetracarboxylic dianhydride, 3,5,6-tricarboxynorbomane-2-acetic 2,3:5,6-dianhydride, decahydro-1,4,5,8-dimethanonaphthalene-2,3,6,7-tetracarboxylic dianhydride, tricyclo[6.4.0.0 (2,7)]dodecane-1,8:2,7-tetracarboxylic dianhydride, octahydro-1H,3H,8H,10H-biphenyleno[4a,4bc:8a,8b-c′]difuran-1,3,8,10-tetraone, ethylene glycolbis(hydrogenated trimellitic anhydride)ester, and decahydro[2]benzopyrano[6,5,4,-def][2]benzopyrano-1,3,6,8-tetarone.

Among the alicyclic tetracarboxylic dianhydrides, from the viewpoint of the transparency and mechanical strength ofthe polyimide-based resin, 1,2,3,4-cyclobutanetetracarboxylic dianhydride (CBDA), 1,2,3,4-cyclopentanetetracarboxylic dianhydride (CPDA), 1,2,4,5-cyclohexanetetracarboxylic dianhydride (H-PMDA) or 1,1′-bicyclohexane-3,3′,4,4′-tetracarboxylic acid-3,4:3′,4′-dianhydride (H-BPDA) is preferable, and 1,2,3,4-cyclobutanetetracarboxylic dianhydride is particularly preferable.

From the viewpoint of improving the compatibility between the polyimide-based resin and the OTHER resin, the content of the alicyclic tetracarboxylic dianhydride with respect to 100 mol % of all acid dianhydride components may be 1 mol % or more, 3 mol % or more, 5 mol % or more, 6 mol % or more, 7 mol % or more, 8 mol % or more, 9 mol % or more, 10 mol % or more, 12 mol % or more, or 15 mol % or more. The amount of the alicyclic tetracarboxylic dianhydride required for imparting the compatibility with the OTHER resin may vary depending on, for example, the type of the OTHER resin and the type of the alicyclic tetracarboxylic dianhydride. For example, when the alicyclic tetracarboxylic dianhydride is 1,2,3,4-cyclobutanetetracarboxylic dianhydride (CBDA), the content of CBDA with respect to 100 mol % of all acid dianhydride components may be 6 mol % or more, 8 mol % or more, or 10 mol % or more.

From the viewpoint of securing the solubility of the polyimide-based resin in an organic solvent, the content of the alicyclic tetracarboxylic dianhydride with respect to 100 mol % of all acid dianhydride components may be 80 mol % or less, 78 mol % or less, 76 mol % or less, 74 mol % or less, 72 mol % or less, 70 mol % or less, 65 mol % or less, 60 mol % or less, 55 mol % or less, or 50 mol % or less. To make the polyimide-based resin soluble in a low-boiling-point halogen-based solvent such as methylene chloride, the content of the alicyclic tetracarboxylic dianhydride may be 45 mol % or less, 40 mol % or less, or 35 mol % or less.

From the viewpoint of making the polyimide-based resin soluble in an organic solvent, it is preferable to contain a fluorine-containing aromatic tetracarboxylic dianhydride or/and a bis(trimellitic anhydride) ester as the acid dianhydride component in addition to the alicyclic tetracarboxylic dianhydride.

Examples of the fluorine-containing aromatic tetracarboxylic dianhydride include 2,2-bis(3,4-dicarboxyphenyl)-1,1,1,3,3,3-hexafluoropropanoic dianhydride and 2,2-bis{4-[4-(1,2-dicarboxy)phenoxy]phenyl}-1,1,1,3,3,3-hexafluoropropanoic dianhydride.

Examples of the bis(trimellitic anhydride) ester include bis(1,3-dioxo-1,3-dihydroisobenzofuran-5-carboxylic acid)-2,2′,3,3′,5,5′-hexamethylbiphenyl-4,4′-diyl (abbreviation: TAINIBP).

From the viewpoint of making the polyimide-based resin soluble in an organic solvent, the total content of the fluorine-containing aromatic tetracarboxylic dianhydride and the bis(trimellitic anhydride) ester with respect to 100 mol % of the total amount of the acid dianhydride components may be 15 mol % or more, 20 mol % or more, 25 mol % or more, 30 mol % or more, 35 mol % or more, 40 mol % or more, 45 mol % or more, or 50 mol % or more. The total content of the fluorine-containing aromatic tetracarboxylic dianhydride and the bis(trimellitic anhydride) ester with respect to 100 mol % of the total amount of the acid dianhydride components may be 99 mol % or less, 95 mol % or less, 90 mol % or less, 85 mol % or less, 80 mol % or less, 75 mol % or less, or 70 mol % or less.

From the viewpoint of obtaining a polyimide-based resin having both solubility in an organic solvent and compatibility with the OTHER resin, the total content of the alicyclic tetracarboxylic dianhydride, the fluorine-containing aromatic tetracarboxylic dianhydride, and the bis(trimellitic anhydride) ester with respect to 100 mol % of the total amount of the acid dianhydride components may be 50 mol % or more, 60 mol % or more, 65 mol % or more, 70 mol % or more, 75 mol % or more, 80 mol % or more, 85 mol % or more, 90 mol % or more, or 95 mol % or more.

The polyimide-based resin may contain, as the acid dianhydride component, an acid dianhydride other than the alicyclic tetracarboxylic dianhydride, the fluorine-containing aromatic tetracarboxylic dianhydride, and the bis(trimellitic anhydride) ester. Examples of acid dianhydrides other than those described above include ethylenetetracarboxylic dianhydride, butanetetracarboxylic dianhydride, 3,3′,4,4′-benzophenonetetracarboxylic anhydride, 2,2′,3,3′-benzophenonetetracarboxylic anhydride, 2,2′,3,3′-biphenyltetracarboxylic dianhydride, pyromellitic dianhydride, 3,3′,4,4′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl) ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 9,9-bis(3,4-dicarboxyphenyl)fluorene dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4[4-(3,4-dicarboxy)phenoxy]phenyl}propane dianhydride, 2,2-bis{4-[3-(1,2-dicarboxy)phenoxy]phenyl}propane dianhydride, bis{4-[4-(1,2-dicarboxy)phenoxy]phenyl}ketone dianhydride, bis{4-[3-(1,2-dicarboxy)phenoxy]phenyl}ketonedianhydride, 4,4′-bis[4-(1,2-dicarboxy)phenoxy]biphenyl dianhydride, 4,4′-bis[3-(1,2-dicarboxy)phenoxy]biphenyl dianhydride, bis{4-[4-(1,2-dicarboxy)phenoxy]phenyl}ketone dianhydride, bis{4-[3-(1,2-dicarboxy)phenoxy]phenyl}ketone dianhydride, bis{4-[4-(1,2-dicarboxy)phenoxy]phenyl}sulfone dianhydride, bis{4-[3-(1,2-dicarboxy)phenoxy]phenyl}sulfone dianhydride, bis{4-[4-(1,2-dicarboxy)phenoxy]phenyl}sulfide dianhydride, bis{4-[3-(1,2-dicarboxy)phenoxy]phenyl}sulfide dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, 1,2,7,8-phenyltetracarboxylic dianhydride, and bis(1,3-dihydro-1,3-dioxo-5-isobenzofurancarboxylic acid)-1,4-phenylene ester.

### (Dicarboxylic Acid)

As described above, the polyimide-based resin may be a polyamideimide in which a part of the tetracarboxylic acid dianhydride component is replaced with a dicarboxylic acid derivative. Examples of the dicarboxylic acid include: aliphatic dicarboxylic acids such as adipic acid, suberic acid, azelaic acid, sebacic acid, and dodecanedioic acid; aromatic dicarboxylic acids such as terephthalic acid, isophthalic acid, 2-chloroterephthalic acid, 2-methylterephthalic acid, 5-methylisophthalic acid, 2,6-naphthalenedicarboxylic acid, 4,4′-oxybisbenzoic acid, 4,4′-biphenyldicarboxylic acid, and 2-fluoroterephthalic acid; alicyclic dicarboxylic acids such as 1,4-cyclohexanedicarboxylic acid, 1,3-cyclohexanedicarboxylic acid, 1,2-hexahydroterephthalic acid, hexahydroisophthalic acid, 1,3-cyclopentanedicarboxylic acid, and bi(cyclohexyl)-4,4′-dicarboxylic acid; and heterocyclic dicarboxylic acids such as 2,5-thiophene dicarboxylic acid and 2,5-furandicarboxylic acid.

From the viewpoint of the solubility of the polyamideimide and compatibility with the OTHER resin, the dicarboxylic acid may be an aromatic dicarboxylic acid or an alicyclic dicarboxylic acid, or an aromatic dicarboxylic acid. Among aromatic dicarboxylic acids, terephthalic acid, isophthalic acid, 4,4′-biphenyl dicarboxylic acid, and 4,4′-oxybisbenzoic acid are preferable, and of these, terephthalic acid and isophthalic acid are preferable, and terephthalic acid is particularly preferable.

As the dicarboxylic acid derivative used as a raw material monomer of the polyamideimide, dicarboxylic acid derivatives such as dicarboxylic acid dichloride, dicarboxylic acid ester, and dicarboxylic acid anhydride are used. Of these, a dicarboxylic acid dichloride is preferable because of its high reactivity.

From the viewpoint of the solubility of the polyamideimide and compatibility with the OTHER resin, the proportion of the dicarboxylic acid derivative to the total of the tetracarboxylic acid dianhydride and the dicarboxylic acid derivative may be 40 mol % or less, 35 mol % or less, or 30 mol % or less. The polyimide-based resin may be a polyimide in which the proportion of the dicarboxylic acid derivative is 0 (that is, containing no structure derived from the dicarboxylic acid derivative).

### (Diamine)

The diamine component of the polyimide-based resin used in one or more embodiments of the present invention is not particularly limited. From the viewpoint of solubility, the diamine ofthe polyimide-based resin may have one or more selected from the group consisting of a fluorine group, a trifluoromethyl group, a sulfone group, a fluorene structure, and an alicyclic structure. Of these, from the viewpoint of achieving both the solubility and the transparency of the polyimide-based resin, the polyimide-based resin may contain a fluorine-containing diamine such as fluoroalkyl-substituted benzidine as the diamine component.

Examples of the fluoroalkyl-substituted benzidine includes fluorine-containing diamine, include 2-(trifluoromethyl)benzidine, 3-(trifluoromethyl)benzidine, 2,3-bis(trifluoromethyl)benzidine, 2,5-bis(trifluoromethyl)benzidine, 2,6-bis(trifluoromethyl)benzidine, 2,3,5-tris(trifluoromethyl)benzidine, 2,3,6-tris(trifluoromethyl)benzidine, 2,3,5,6-tetrakis(trifluoromethyl)benzidine, 2,2′-bis(trifluoromethyl)benzidine, 3,3′-bis(trifluoromethyl)benzidine, 2,3′-bis(trifluoromethyl)benzidine, 2,2′,3-bis(trifluoromethyl)benzidine, 2,3,3′-tris(trifluoromethyl)benzidine, 2,2′,5-tris(trifluoromethyl)benzidine, 2,2′,6-tris(trifluoromethyl)benzidine, 2,3′,5-tris(trifluoromethyl)benzidine, 2,3′,6,-tris(trifluoromethyl)benzidine, 2,2′,3,3′-tetrakis(trifluoromethyl)benzidine, 2,2′,5,5′-tetrakis(trifluoromethyl)benzidine, and 2,2′,6,6′-tetrakis(trifluoromethyl)benzidine.

Of these, a fluoroalkyl-substituted benzidine having a fluoroalkyl group at the 2-position of biphenyl is preferable, and 2,2′-bis(trifluoromethyl)benzidine (hereinafter, referred to as “TFMB”) is particularly preferable. When fluoroalkyl groups are present at the 2-position and 2′-position of biphenyl, the r-electron density decreases because of the electron-attracting property of the fluoroalkyl group, and a bond between two benzene rings of biphenyl is twisted by steric hindrance of the fluoroalkyl group, leading to a decrease in planarity of the n-conjugate. Thus, the absorption edge wavelength shifts to a short wave, and thus coloring of the polyimide-based resin can be suppressed.

The content of the fluoroalkyl-substituted benzidine with respect to 100 mol % of the total amount of the diamine components may be 50 mol % or more, 60 mol % or more, 70 mol % or more, 80 mol % or more, 85 mol % or more, or 90 mol % or more. A large content of the fluoroalkyl-substituted benzidine tends to lead to suppression of coloring of the film and enhancement of mechanical strength in terms of pencil hardness, elastic modulus, and the like.

The polyimide-based resin may contain a diamine other than the fluoroalkyl-substituted benzidine as the diamine component. Examples of the diamine other than the fluoroalkyl-substituted benzidine include p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenylsulfone, 3,4′-diaminodiphenylsulfone, 4,4′-diaminodiphenylsulfone, 9,9-bis(4-aminophenyl)fluorene, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl) benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-phenoxybenzophenone, 6,6′-bis(3-aminophenoxy)-3,3,3′,3′-tetramethyl-1,1′-spirobiindan, 6,6′-bis(4-aminophenoxy)-3,3,3′,3′-tetramethyl-1,1′-spirobiindan, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, 1,3-di(2-aminoethyl)cyclohexane, 1,4-di(2-aminoethyl)cyclohexane, bis(4-aminocyclohexyl)methane, 2,6-bis(aminomethyl)bicyclo[2.2.1]heptane, 2,5-bis(aminomethyl)bicyclo[2.2.1]heptane, 1,4-diamino-2-fluorobenzene, 1,4-diamino-2,3-difluorobenzene, 1,4-diamino-2,5-difluorobenzene, 1,4-diamino-2,6-difluorobenzene, 1,4-diamino-2,3,5-trifluorobenzene, 1,4-diamino, 2,3,5,6-tetrafluorobenzene, 1,4-diamino-2-(trifluoromethyl)benzene, 1,4-diamino-2,3-bis(trifluoromethyl)benzene, 1,4-diamino-2,5-bis(trifluoromethyl)benzene, 1,4-diamino-2,6-bis(trifluoromethyl)benzene, 1,4-diamino-2,3,5-tris(trifluoromethyl)benzene, 1,4-diamino, 2,3,5,6-tetrakis(trifluoromethyl)benzene, 2,2′-dimethylbenzidine, 2-fluorobenzidine, 3-fluorobenzidine, 2,3-difluorobenzidine, 2,5-difluorobenzidine, 2,6-difluorobenzidine, 2,3,5-trifluorobenzidine, 2,3,6-trifluorobenzidine, 2,3,5,6-tetrafluorobenzidine, 2,2′-difluorobenzidine, 3,3′-difluorobenzidine, 2,3′-difluorobenzidine, 2,2′,3-trifluorobenzidine, 2,3,3′-trifluorobenzidine, 2,2′,5-trifluorobenzidine, 2,2′,6-trifluorobenzidine, 2,3′,5-trifluorobenzidine, 2,3′,6-trifluorobenzidine, 2,2′,3,3′-tetrafluorobenzidine, 2,2′,5,5′-tetrafluorobenzidine, 2,2′,6,6′-tetrafluorobenzidine, 2,2′,3,3′,6,6′-hexafluorobenzidine, and 2,2′,3,3′,5,5′,6,6′-octafluorobenzidine.

For example, by using diaminodiphenylsulfone as the diamine in addition to the fluoroalkyl-substituted benzidine, the solvent-solubility and transparency of the polyimide-based resin may be improved. Among the diaminodiphenylsulfones, 3,3′-diaminodiphenylsulfone (3,3′-DDS) and 4,4′-diaminodiphenylsulfone (4,4′-DDS) are preferable. 3,3′-DDS and 4,4′-DDS may be used in combination. The content of diaminodiphenylsulfone with respect to 100 mol % of all diamines may be 1 to 40 mol %, 3 to 30 mol %, or 5 to 25 mol %.

### (Preparation of Polyimide-Based Resin)

A polyamic acid as a polyimide precursor is obtained through the reaction between the acid dianhydride and the diamine, and the polyimide is obtained through cyclodehydration (imidization) of the polyamic acid. A method for preparing the polyamic acid is not particularly limited, and any known method can be used. For example, a polyamic acid solution is obtained by dissolving the diamine and the tetracarboxylic dianhydride in an organic solvent in substantially equimolar amounts (molar ratio of 90:100 to 110:100) and stirring the mixture.

In preparation of the polyamideimide, a dicarboxylic acid or a derivative thereof (dicarboxylic acid dichloride, dicarboxylic acid anhydride, or the like) may be used as a monomer in addition to the diamine and the tetracarboxylic dianhydride. In this case, the amount of each monomer can be adjusted such that the total amount of the tetracarboxylic dianhydride and the dicarboxylic acid or a derivative thereofis substantially equimolar amount to the amount of the diamine.

As described above, the polyimide-based resin exhibits transparency, solubility in an organic solvent, and compatibility with OTHER resin, by adjusting its composition, i.e., the type and proportion of the acid dianhydride and the diamine.

The concentration of the polyamic acid solution is typically 5 to 35 wt %, or 10 to 30 wt %. When the concentration is within this range, the polyamic acid obtained through polymerization has an appropriate molecular weight, and the polyamic acid solution has an appropriate viscosity.

In the polymerization of the polyamic acid, a method is preferable in which the acid dianhydride is added to the diamine for suppressing ring opening of the acid dianhydride. When adding a plurality of types of diamine and a plurality of types of acid dianhydride are added, they may be added at one time, or may be added in a plurality of times. Various physical properties of the polyimide-based resin can also be controlled by adjusting the order of addition of monomers.

The organic solvent used for polymerization of the polyamic acid is not particularly limited as long as it does not react with the diamine or the acid dianhydride but can dissolve the polyamic acid. Examples of the organic solvent include urea-based solvents such as methylurea and N,N-dimethylethylurea; sulfoxide or sulfone-based solvents such as dimethyl sulfoxide, diphenylsulfone and tetramethylsulfone; amide-based solvents such as N,N-dimethyacetamide (DMAc), N,N-dimethylformamide (DMF), N,N-diethylacetamide, N-methyl-2-pyrrolidone (NMP), 7-butyrolactone and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolane, 1,4-dioxane, dimethyl ether, diethyl ether and p-cresol methyl ether. These solvents are typically used singly, or as necessary, two or more thereof are used in combination as appropriate. From the viewpoint of the solubility and polymerization reactivity of the polyamic acid, DMAc, DMF, NMP and the like may be used.

A polyimide-based resin can be obtained through cyclodehydration of the polyamic acid. Examples of the method for preparing the polyimide-based resin from a polyamic acid solution include a method in which a dehydrating agent, an imidization catalyst and the like are added to a polyamic acid solution to advance imidization in the solution. The polyamic acid solution may be heated to accelerate the progress of imidization. By mixing a poor solvent with a solution containing the polyimide-based resin generated through imidization of the polyamic acid, a polyimide-based resin is precipitated as a solid. By isolating the polyimide-based resin as a solid substance, impurities generated during synthesis of the polyamic acid, and the residual dehydration agent and the imidization catalyst and the like can be washed and removed with the poor solvent, and thus, it is possible to prevent coloring of the polyimide-based resin and an increase in yellowness index. By isolating the polyimide-based resin as a solid, a solvent suitable for forming a film, such as a low-boiling-point solvent, can be applied in preparation of a solution for producing a film.

The molecular weight (weight-average molecular weight in terms of polyethylene oxide which is measured by gel permeation chromatography (GPC)) of the polyimide-based resin may be 10,000 to 300,000, 20,000 to 250,000, or 40,000 to 200,000. An excessively small molecular weight may result in insufficient strength of the film. An excessively large molecular weight may result in poor compatibility with the OTHER resin.

The polyimide-based resin may be soluble in a low-boiling-point solvent such as a ketone-based solvent or a halogenated alkyl-based solvent. The phrase “the polyimide-based resin exhibits solubility in a solvent” means that the polyimide-based resin is dissolved at a concentration of 5 wto or more. In one or more embodiments, the polyimide-based resin exhibits solubility in methylene chloride. Methylene chloride has a low boiling point, and thus it is easy to remove the residual solvent at the time of producing a film. Thus, the use of a polyimide-based resin soluble in methylene chloride can be expected to improve productivity of the film.

From the viewpoint of thermal stability and light stability of the transparent resin film, the polyimide-based resin may have low reactivity. The acid value of the polyimide-based resin may be 0.4 mmol/g or less, 0.3 mmol/g or less, or 0.2 mmol/g or less. The acid value of the polyimide may be 0.1 mmol/g or less, 0.05 mmol/g or less, or 0.03 mmol/g or less. From the viewpoint of reducing the acid value, the polyimide-based resin may have a high imidization ratio. A small acid value tends to lead to enhancement of the stability of the polyimide-based resin and improvement in compatibility with the OTHER resin.

### <OTHER Resin>

As described above, in addition to the polyimide-based resin, the transparent resin film 1 contains a resin other than the polyimide-based resin (“OTTER resin”). The OTHER resin is not particularly limited as long as it is soluble in an organic resin and can be mixed with the polyimide-based resin to form a transparent film, and examples thereof include those capable of being compatible with the polyimide-based resin and those forming a microphase separation structure such as a sea-island structure, a cylinder structure, or a lamellar structure. Of these, the OTHER resin may be compatible with the polyimide-based resin. When the polyimide-based resin and the OTTER resin are compatible with each other, there is a tendency that transparency is high, and mechanical properties such as elastic modulus and pencil hardness are excellent regardless of processing conditions of the film.

The OTHER resin may be a transparent resin having a refractive index lower than that of the polyimide-based resin. The refractive index of the OTTER resin may be 1.600 or less, 1.550 or less, 1.520 or less, or 1.500 or less. Due to the fact that the OTTER resin has a refractive index lower than that of the polyimide-based resin, the transparent resin film containing the polyimide-based resin and the OTTER resin has a refractive index lower than that of a film containing the polyimide-based resin alone, and has small reflection at the interface, so that the total light transmittance tends to be high.

Examples of the OTHER resin include an acryl-based resin, a polycarbonate-based resin, a polyester-based resin, a polyamide-based resin, a polyether-based resin, a cellulose-based resin, a silicone-based resin, and a cyclic olefin-based resin. A plurality of types of these resins may be used. From the viewpoint of high compatibility with the polyimide-based resin, preferable examples of the OTTER resin include an acryl-based resin, a polycarbonate-based resin, and a polyester-based resin having a fluorene structure. Of these, an acryl-based resin is particularly preferable because it exhibits high compatibility with the polyimide-based resin, has a low refractive index, and easily forms a film having high hardness.

Examples of the acryl-based resin include poly(meth)acrylic acid esters such as polymethyl methacrylate, methyl methacrylate-(meth)acrylic acid copolymers, methyl methacrylate-(meth)acrylic acid ester copolymers, methyl methacrylate-acrylic acid ester-(meth)acrylic acid copolymers, and methyl(meth)acrylate-styrene copolymers. The acryl-based resin may have a glutarimide structural unit or a lactone ring structural unit introduced through modification.

From the viewpoint of transparency, compatibility with the polyimide-based resin, and mechanical strength, the acryl-based resin may have methyl methacrylate as a main structural unit. The amount of methyl methacrylate with respect to the amount of all monomer components in the acryl-based resin may be 60 wt % or more, 70 wt % or more, 80 wt % or more, 85 wt % or more, 90 wt % or more, or 95 wt % or more. The acryl-based resin may be a homopolymer of methyl methacrylate. The acryl-based resin may be obtained by introducing a glutarimide structure or a lactone ring structure into an acryl-based polymer having a methyl methacrylate content in the above range.

From the viewpoint of the heat resistance of the transparent resin film, the glass transition temperature of the acryl-based resin may be 100 °C or higher, 110 °C or higher, 115 °C or higher, or 120 °C or higher.

From the viewpoint of solubility in an organic solvent, compatibility with the polyimide-based resin, and film strength, the weight-average molecular weight of the acryl-based resin (in terms of polystyrene) may be 5,000 to 500,000, 10,000 to 300,000, or 15,000 to 200,000.

From the viewpoint of the heat stability and light stability of the film, it is preferable that the content of reactive functional groups such as ethylenically unsaturated groups and carboxy groups in the acryl-based resin is small. The iodine value of the acryl-based resin may be 10.16 g/100 g (0.4 mmol/g) or less, 7.62 g/100 g (0.3 mmol/g) or less, or 5.08 g/100 g (0.2 mmol/g) or less. The iodine value of the acryl-based resin may be 2.54 g/100 g (0.1 mmol/g) or less, or 1.27 g/100 g (0.05 mmol/g) or less. The acid value of the acryl-based resin may be 0.4 mmol/g or less, 0.3 mmol/g or less, or 0.2 mmol/g or less. The acid value of the acryl-based resin may be 0.1 mmol/g or less, 0.05 mmol/g or less, or 0.03 mmol/g or less. A small acid value tends to lead to enhancement of the stability of the acryl-based resin and improvement of compatibility with the polyimide-based resin.

### <Composition of Transparent Resin Film>

As described above, the transparent resin film 1 is a blended resin film containing a polyimide-based resin and OTHER resin as resin components. The ratio between the polyimide-based resin and the OTHER resin in the transparent resin film is not particularly limited. The mixing ratio (weight ratio) of the polyimide-based resin and the OTHER resin may be 98:2 to 2:98, 95:5 to 10:90, 90:10 to 15:85, or 65:35 to 50:50. When the ratio of the polyimide-based resin is high, the elastic modulus and the pencil hardness of the film tends to increase, resulting in excellent mechanical strength. A higher ratio of the OTHER resin tends to lead less coloring of the film, higher total light transmittance, lower yellowness index (YI), and higher transparency.

To sufficiently exhibit the effect of improving the transparency by mixing the polyimide-based resin and the OTHER resin, the ratio of the OTHER resin based on the total of the polyimide-based resin and the OTHER resin may be 10 to 90 wt %, 15 to 85 wt %, 20 to 80 wt %, 30 to 70 wt %, 35 to 65 wt %, or 40 to 60 wt %.

In addition to the resin components, the transparent resin film may contain an organic or inorganic low-molecular-weight compound or the like. The transparent resin film may contain, as an additive, a bluing agent, an ultraviolet absorber, a flame retardant, a stabilizer, a crosslinking agent, a surfactant, a leveling agent, a plasticizer, fine particles, or the like.

For the purpose of improving blocking resistance, adjusting a refractive index, and the like, the transparent resin film may contain organic fine particles such as polystyrene and a crosslinked acryl-based resin, and inorganic fine particles such as silica and a layered silicate. However, blending fine particles may cause a decrease in transmittance and an increase in haze of the film. In particular, silicon oxide such as silica is useful for reducing the refractive index of the film, but is likely to cause poor dispersion in the resin matrix, and is likely to cause deterioration in transparency, mechanical strength, and bending resistance. Thus, the content of the silicon oxide may be 5 parts by weight or less, 1 part by weight or less, 0.5 parts by weight or less, or 0.1 parts by weight or less or may be 0 with respect to 100 parts by weight of the total of the resin components.

### <Production of Transparent Resin Film>

The transparent resin film 1 is prepared by a solution method in which a solution containing the polyimide-based resin and the OTHER resin is applied onto a support, and the solvent is then dried and removed.

The solvent is not particularly limited as long as it exhibits solubility to both the polyimide-based resin and the OTHER resin. Examples of the solvent include amide-based solvents such as N,N-dimethylformamide, N,N-dimethylacetamide and N-methyl-2-pyrrolidone; ether-based solvents such as tetrahydrofuran and 1,4-dioxane; ketone-based solvents such as acetone, methyl ethyl ketone, methyl propyl ketone, methyl isopropyl ketone, methyl isobutyl ketone, diethyl ketone, cyclopentanone, cyclohexanone, and methyl cyclohexanone; and halogenated alkyl solvents such as chloroform, 1,2-dichloroethane, 1,1,2,2-tetrachloroethane, chlorobenzene, dichlorobenzene, and methylene chloride. Of these, a ketone-based solvent and an alkyl halide-based solvent are preferable because the polyimide resin or the like has excellent solubility in the solvents, the solvents have a low boiling point, and the residual of the solvents at the time of film production can be easily removed.

As a method for applying the resin solution onto a support, a known method using a bar coater, a comma coater or the like can be applied. As the support, a glass substrate, a metal substrate, a metal drum or a metal belt made of SUS or the like, a plastic film, or the like can be used. From the viewpoint of improving productivity, it is preferable to produce a film by a roll-to-roll process using an endless support such as a metal drum or a metal belt, a long plastic film or the like as a support. When a plastic film is used as the support, a material that is not soluble in the solvent of the resin solution (dope) may be appropriately selected.

Heating may be performed when the solvent is dried. The heating temperature is not particularly limited as long as the solvent can be removed, and coloring of the resulting film can be suppressed, and the temperature is appropriately set to room temperature to about 250 °C, or 50 °C to 220 °C. The heating temperature may be elevated stepwise. To enhance the solvent removal efficiency, the resin film may be peeled off from the support and dried after the drying proceeds to some extent. Drying can be performed in an air atmosphere or a nitrogen atmosphere. To promote the removal of the solvent, heating may be performed under reduced pressure.

For the purpose of, for example, improving the mechanical strength of the film, the film may be stretched in one direction or a plurality of directions. When the film is stretched, polymer chains are aligned along the stretching direction, and thus, the strength in an in-plane direction of the film is improved and the occurrence of breaking and cracking of the film tends to be suppressed.

Although a film made of an acryl-based resin alone may have low toughness, strength of a film may be improved by employing a system in which a polyimide-based resin and an acryl-based resin are compatible with each other. In addition, when a compatible film of a polyimide-based resin and an acryl-based resin is stretched, since polymer chains orient along the stretching direction, the tensile modulus in the stretching direction tends to increase, and accordingly, the bending resistance tends to improve.

For example, a film used as a cover window material or a substrate material for a foldable display device is repeatedly bent along a bending axis at the same position. Such a film is required to have high mechanical strength in a direction perpendicular to the bending axis. Thus, by disposing the film such that the stretching direction of the film is perpendicular to the bending axis, the film is hardly broken or cracked at the bent portion even though bending is repeated, and a device having high bending resistance can be provided.

Stretching conditions of the film are not particularly limited. For example, the stretching temperature is about ±40 °C of the glass transition temperature of the film, and the temperature may be about 120 to 300 °C, 150 to 250 °C, or 180 to 230 °C. The stretching ratio is about 30 to 200%, and it may be 50 to 150%, 80 to 120%, or 80 to 100%. The tensile modulus in the stretching direction tends to increase as the stretching ratio increases. On the other hand, when the stretching ratio is excessively large, the mechanical strength in the direction perpendicular to the stretching direction tends to decrease, and the handleability of the film may decrease.

From the viewpoint of enhancing the strength in all directions in the film plane, the film may be biaxially stretched. The biaxial stretching may be simultaneous biaxial stretching or sequential biaxial stretching. In the biaxial stretching, the stretching ratio in one direction and the stretching ratio in a direction perpendicular to the one direction may be the same or different. When a stretching ratio in one direction is different from a stretch direction in another direction, the mechanical strength in a direction in which the stretching ratio is larger tends to be relatively large. When a biaxially stretched film having anisotropy in stretching ratio is used for a foldable device, it is preferable to dispose the biaxially stretched film such that a direction in which the stretching ratio is relatively larger comes to a direction perpendicular to the bending axis.

From the viewpoint of imparting a self-supporting property to a film and imparting strength applicable as a cover window material, the thickness of the transparent resin film 1 is 26 μm or more, and may be 30 μm or more, 35 μm or more, or 40 μm or more. From the viewpoint of securing bendability (flexibility) applicable to a foldable device, the thickness of the transparent resin film 1 may be 100 μm or less, 80 μm or less, 70 μm or less, 60 μm or less, or 50 μm or less.

When the transparent resin film 1 is a stretched film, the thickness after stretching may be within the above range. The thickness of the film before stretching may be 50 μm or more, 80 μm or more, 100 μm or more, or 120 μm or more.

In the transparent resin film 1, the arithmetic mean roughness Sa of at least one principal surface is 1 nm or less, and may be 0.5 nm or less. In the transparent resin film 1, the maximum height Sz of at least one principal surface may be 70 nm or less, 50 nm or less, 30 nm or less, or 10 nm or less.

When the surface roughness of one principal surface (first principal surface) of the transparent resin film 1 is small and Sa and Sz are within the above ranges, even in the case where Sa and Sz of the other principal surface (second principal surface) are large, the surface irregularities of the transparent resin film are filled by forming the hard coat layer 3 on the principal surface having a relatively large surface roughness, so that whitening unevenness can be suppressed. Therefore, the other principal surface (second principal surface) ofthe transparent resin film 1 may have an arithmetic mean roughness Sa and a maximum height Sz larger than Sa and Sz of the one principal surface (first principal surface).

The arithmetic mean roughness Sa of the second principal surface 1B of the transparent resin film 1 may be larger than 1 nm, and may be 1.5 nm or more. When the arithmetic mean roughness Sa of the second principal surface 1B of the transparent resin film 1 is excessively large, whitening unevenness may not be sufficiently suppressed even when a hard coat layer is formed. Therefore, the arithmetic mean roughness Sa of the second principal surface 1B of the transparent resin film 1 may be 100 nm or less, 50 nm or less, or 20 nm or less.

The maximum height Sz of the second principal surface 1B of the transparent resin film 1 may be larger than 10 nm, and may be 30 nm or more, 50 nm or more, 70 nm or more, or 72 nm or more. The maximum height Sz of the second principal surface 1B of the transparent resin film 1 may be 1000 nm or less, 500 nm or less, 300 nm or less, 200 nm or less, or 100 nm or less.

Sa and Sz are the arithmetic mean roughness (arithmetic mean height) Sa and the maximum height Sz, respectively, of a contour curved surface defined by ISO 25178-2 (JIS B 0681-2:2018), and are indexes representing surface roughness. Sa and Sz are determined from a contour curved surface obtained by filtering a three-dimensional surface shape in a range of 0.28 mm×0.21 mm measured by a vertical scanning low coherence interferometry in accordance with ISO 25178-604 using an interference non-contact three-dimensional roughness meter and removing the influence of undulation and thickness unevenness.

In a film obtained by applying a resin solution onto a support and drying and removing a solvent, surface irregularities of the support are transferred to the surface (the B surface) peeled from the support. When the support is a plastic film, the plastic film has surface irregularities to ensure slipperiness at the time of conveying the film and to prevent blocking at the time of winding the film into a roll form. When the support is an endless belt, the belt has surface irregularities of the material constituting the belt and surface irregularities caused by a peeling residue or scratches due to repeated use of the belt.

The B surface of the transparent resin film 1 often has an arithmetic mean roughness Sa larger than 1 nm because the surface irregularities of the support are transferred. On the other hand, the air surface (the A surface), which is a surface opposite from the support during film formation, is not affected by the surface irregularities of the support, and thus is smoother than the B surface, and the arithmetic mean roughness Sa is likely to be 1 nm or less.

### <Whitening Unevenness of Transparent Resin Film>

When a transparent resin film having a thickness of26 μm or more produced by a solution method is visually recognized from an oblique direction (a direction deviated from a normal direction of the film plane), the entire film plane is visually recognized as whitish, and variation in density of whiteness may be visually recognized as whitening unevenness. In particular, when the surface roughness of one surface of the transparent resin film is large, whitening unevenness is easily visually recognized.

The thickness unevenness tends to increase as the thickness of the film increases, and this tendency is particularly remarkable when a composition containing a polyimide-based resin is formed into a film by a solution method. This tendency is considered to be related to the fact that polyimide has a strong intermolecular interaction, aggregation of polymer molecules occurs in a drying process, and thickness unevenness is likely to occur in a film plane due to mass transfer associated with the aggregation.

The thickness unevenness of the film before stretching may be −20 μm to +20 μm, −10 μm to +10 μm, −5 μm to +5 μm, −3 μm to +3 μm, or −1 μm to +1 μm with respect to average thickness. Although the thickness unevenness of the film tends to be reduced by stretching, the pattern of the thickness unevenness does not change. When the thickness of the film after stretching is 26 μm or more, the thickness unevenness is still large, and the whitening unevenness is easily visually recognized.

When the arithmetic mean roughness Sa of the film surface is larger than 1 nm, since the transmitted light is scattered, the entire surface of the film may be visually recognized as being slightly whitish, but this alone is not visually recognized as unevenness. It is considered that when, in addition to the surface roughness of a film, the thickness unevenness of the film is large, since the incident angle of the transmitted light varies in-plane, variation in scattering intensity of the light occurs, and in viewing from an oblique direction, there is a portion where the scattered light is strongly visually recognized and looks white and there is variation in whiteness in the film plane, so that the variation in whiteness is recognized as whitening unevenness. As will be described later, by providing the hard coat layer 3 on the principal surface of the transparent resin film 1 having a relatively large surface roughness (generally the B surface), surface irregularities are filled, and whitening unevenness tends to be hardly visually recognized.

### <Properties of Transparent Resin Film>

It is preferable that the transparent resin film has a single glass transition temperature in differential scanning calorimetry (DSC) and/or dynamic mechanical analysis (DMA). When the polyimide-based resin and another resin contained in the transparent resin film exhibit compatibility, the transparent film has a single glass transition temperature.

The haze of the transparent resin film may be 10% or less, 5% or less, 4% or less, 3.5% or less, 3% or less, 2% or less, 1% or less, or 0.5% or less. When the transparent resin film contains a polyimide-based resin and OTHER resin, low haze can be achieved by using a resin having high compatibility with the polyimide-based resin such as an acryl-based resin as OTHER resin.

The total light transmittance of the transparent resin film may be 90.3% or more, 90.5% or more, 91.0% or more, or 91.5% or more. As the total light transmittance is higher, the white luminance of the display is higher, and the display is superior in visibility. As described above, mixing the polyimide-based resin with the OTHER resin tends to lower the refractive index and increase the total light transmittance as compared with the case of the polyimide-based resin alone.

The yellowness index (YI) of the transparent resin film may be 3.0 or less, 2.0 or less, or 1.0 or less. The yellowness index (YI) of the transparent resin film may be −3.0 or more, −2.0 or more, or −1.0 or more. By mixing the polyimide-based resin with the OTHER resin such as an acryl-based resin, a film is obtained which is less colored and has smaller absolute value of YI as compared to a case where the polyimide-based resin is used alone.

The refractive index of the transparent resin film may be 1.600 or less. The refractive index of a film is an average of an in-plane maximum refractive index and an in-plane minimum refractive index of the film. The refractive index of the transparent resin film may be 1.580 or less, 1.560 or less, 1.540 or less, or 1.520 or less.

The refractive index of a film containing only a polyimide-based resin as the resin component is typically higher than 1.600, and light reflection due to a difference in refractive index from an air interface or an interface with another member is large (reflectance is high), and thus light transmittance is small. Since the mixed-resin of the polyimide-based resin and the OTHER resin has a lower refractive index than the case of the polyimide-based resin alone, light reflection at the interface is reduced, and the total light transmittance is increased. In particular, since an acryl-based resin has a low refractive index, when an acryl-based resin is used as the OTHER resin, the film tends to have a low refractive index and a high total light transmittance.

The tensile modulus of the transparent resin film may be 3.0 GPa or more, 3.5 GPa or more, 4.5 GPa or more, 5.0 GPa or more, 5.5 GPa or more, or 6.0 GPa or more. The larger the tensile modulus is, the better the mechanical strength, such as hardness or bending resistance, tends to be.

The transparent resin film may have in-plane anisotropy in tensile modulus. When the transparent resin film is a stretched film, the tensile modulus in the stretching direction tends to be larger than the tensile modulus in a direction perpendicular to the stretching direction. When the transparent resin film is a biaxially stretched film or a fixed-end uniaxially stretched film, the tensile modulus in all directions in the plane may be larger than that before stretching. When the transparent resin film has in-plane anisotropy of tensile modulus, the maximum in-plane tensile modulus (generally, tensile modulus in the stretching direction) may be in the above range.

### [Hard Coat Layer]

The hard coat film of one or more embodiments of the present invention has a hard coat layer 3 on one surface of the transparent resin film 1. By providing the hard coat layer 3 on a surface of the transparent resin film 1, the scratch resistance and the hardness are enhanced. By providing the hard coat layer 3 on the transparent resin film 1 on the principal surface having a relatively large surface roughness, whitening unevenness is suppressed.

The material constituting the hard coat layer is not particularly limited as long as it has a function of preventing generation of scratches, and examples thereof include polyester-based resins, acryl-based resins, urethane-based resins, amide-based resins, siloxane-based resins and epoxy-based resins. Of these, an acryl-based hard coat layer which is a cured product of an acryl-based hard coat resin composition or a siloxane-based hard coat layer which is a cured product of a siloxane-based hard coat resin composition is preferable from the viewpoint of preventing generation of scratches.

### <Acryl-Based Hard Coat Material>

The acryl-based hard coat material contains a monomer or oligomer having a (meth)acryloyl group in the molecule as a curable resin component. The molecular weight of the acrylic monomer or oligomer is, for example, about 200 to 10,000. The acryl-based hard coat material can control hardness, scratch resistance, bending resistance, optical characteristics, and the like by combining a plurality of monomers or oligomers having a (meth)acryloyl group. From the viewpoint of curability in photoradical polymerization, the hard coat material may have an acryloyl group.

Specific examples ofthe oligomer having a (meth)acryloyl group include urethane (meth)acrylate, polyester (meth)acrylate, and epoxy (meth)acrylate. The oligomer may have two or more (meth)acryloyl groups in one molecule. The molecular weight of the oligomer may be 10,000 or less.

Examples of the acrylic monomer include compounds having one (meth)acryloyl group, such as methyl (meth)acrylate and 2-ethylhexyl (meth)acrylate; compounds having two (meth)acryloyl groups in one molecule, such as ethylene glycol di(meth)acrylate, polyethylene glycol di(meth)acrylate, propylene glycol di(meth)acrylate, polypropylene glycol di(meth)acrylate, 1,4-butanediol di(meth)acrylate, 1,3-butylene glycol di(meth)acrylate, and 1,6-hexanediol di(meth)acrylate; and compounds having three or more (meth)acryloyl groups in one molecule, such as glycerin tri(meth)acrylate, trimethylolpropane tri(meth)acrylate, ditrimethylolpropane tetra(meth)acrylate, pentaerythritol tri(meth)acrylate, pentaerythritol tetra(meth)acrylate, dipentaerythritol tetra(meth)acrylate, dipentaerythritol penta(meth)acrylate, and dipentaerythritol hexa(meth)acrylate.

From the viewpoint of enhancing the scratch resistance of the hard coat layer, the acryl-based hard coat material may contain a tri- or more polyfunctional (meth)acrylate. The functional group equivalent of the (meth)acryloyl group of the polyfunctional (meth)acrylate, that is, the molecular weight per (meth)acryloyl group may be 80 to 150 g/eq. Among the polyfunctional (meth)acrylates recited as examples above, dipentaerythritol hexa(meth)acrylate is particularly preferable.

### <Siloxane-Based Hard Coat Material>

The siloxane-based hard coat material contains a curable compound having a siloxane bond as a curable resin component. From the viewpoint of resistance to scratches, the siloxane-based curable compound may have an epoxy group as a polymerizable functional group, and in particular, a polyorganosiloxane compound containing an alicyclic epoxy group is preferable. Such siloxane-based hard coat materials are disclosed in WO 2014/204010 A, WO 2018/096729 A, WO 2020/040209 A, and the like, and these descriptions can be referred to and incorporated.

Since a siloxane-based hard coat material having an alicyclic epoxy group as a polymerizable functional group has small curing shrinkage during curing, curling and cracking are less likely to occur even when the thickness of the hard coat layer is increased. Since the thickness of the hard coat layer can be made large, it is advantageous for improving the dent resistance and the dent recoverability.

A polyorganosiloxane compound having an alicyclic epoxy group is obtained by condensation of a silane compound of general formula (1).

[Y—Si(OR¹)ₓR²₃₋ₓ] (1)

In the general formula (1), R¹ is a hydrogen atom or an alkyl group having 1 to 10 carbon atoms. Specific examples of the alkyl group include a methyl group, an ethyl group, a propyl group, a butyl group, a pentyl group, a hexyl group, a heptyl group, an octyl group, a nonyl group, a decyl group, an isopropyl group, an isobutyl group, a cyclohexyl group, and an ethylhexyl group.

The silane compound represented by general formula (1) has two or three (—OR)s in one molecule. Since Si—OR¹ is hydrolyzable, a polyorganosiloxane compound is obtained by condensation of a silane compound. From the viewpoint of hydrolyzability, the number of carbon atoms in R¹ may be 3 or less, and R¹ may be a methyl group.

In the general formula (1), R² is a hydrogen atom, or a monovalent hydrocarbon group selected from the group consisting of an alkyl group having 1 to 10 carbon atoms, an aryl group having 6 to 25 carbon atoms, and an aralkyl group having 7 to 12 carbon atoms. Specific examples of the hydrocarbon group include a methyl group, an ethyl group, a propyl group, a butyl group, a pentyl group, a hexyl group, a heptyl group, an octyl group, a nonyl group, a decyl group, an isopropyl group, an isobutyl group, a cyclohexyl group, an ethylhexyl group, a benzyl group, a phenyl group, a tolyl group, a xylyl group, a naphthyl group, and a phenethyl group.

In the general formula (1), x is 2 or 3, and when x=3 (that is, when three alkoxy groups (or hydroxy groups) —OR¹ are bonded to the Si atom), the silane compound does not have R². From the viewpoint of forming a net-shaped polyorganosiloxane compound, and increasing the number of epoxy groups contained in the polyorganosiloxane compound to increase the hardness of a cured film, it is preferable that x=3 in the general formula (1). A silane compound with x=2 and a silane compound with x=3 may be used in combination. A silane compound with x being 1 may be used in addition to the silane compound with x being 2 or 3 for the purpose of, for example, adjusting the molecular weight of the polyorganosiloxane compound to be obtained via condensation.

In the general formula (1), Y is a monovalent organic group containing an alicyclic epoxy group. Examples of Y include an alicyclic epoxy group, an alkyl group having an alicyclic epoxy group as a substituent, and an alkylene glycol group having an alicyclic epoxy group as a substituent. From the viewpoint of heat resistance and bending resistance, the alkyl group having an alicyclic epoxy group as a substituent is preferable.

Specific examples of the alkyl group having an alicyclic epoxy group as a substituent include a (3,4-epoxycyclohexyl)methyl group, a 2-(3,4-epoxycyclohexyl)ethyl group, a 3-(3,4-epoxycyclohexyl)propyl group, a 4-(3,4-epoxycyclohexyl)butyl group, a 5-(3,4-epoxycyclohexyl)pentyl group, a 6-(3,4-epoxycyclohexyl)hexyl group, a 7-(3,4-epoxycyclohexyl)heptyl group, an 8-(3,4-epoxycyclohexyl)octyl group, a 9-(3,4-epoxycyclohexyl)nonyl group, a 10-(3,4-epoxycyclohexyl)decyl group, a 11-(3,4-epoxycyclohexyl)undecyl group, and a 12-(3,4-epoxycyclohexyl)dodecyl group.

Specific examples of the silane compound represented by the general formula (1) include (3,4-epoxycyclohexyl)trimethoxysilane, (3,4-epoxycyclohexyl)methyldimethoxysilane, (3,4-epoxycyclohexyl)dimethylmethoxysilane, (3,4-epoxycyclohexyl)triethoxysilane, (3,4-epoxycyclohexyl)methyldiethoxysilane, (3,4-epoxycyclohexyl)dimethylethoxysilane, {(3,4-epoxycyclohexyl)methyl}trimethoxysilane, {(3,4-epoxycyclohexyl)methyl}methyldimethoxysilane, {(3,4-epoxycyclohexyl)methyl}dimethylmethoxysilane, {(3,4-epoxycyclohexyl)methyl}triethoxysilane, {(3,4-epoxycyclohexyl)methyl}methyldiethoxysilane, {(3,4-epoxycyclohexyl)methyl}dimethylethoxysilane, {2-(3,4-epoxycyclohexyl)ethyl}trimethoxysilane, {2-(3,4-epoxycyclohexyl)ethyl}methyldimethoxysilane, {2-(3,4-epoxycyclohexyl)ethyl}dimethylmethoxysilane, {2-(3,4-epoxycyclohexyl)ethyl}triethoxysilane, {2-(3,4-epoxycyclohexyl)ethyl}methyldiethoxysilane, and {2-(3,4-epoxycyclohexyl)ethyl}dimethylethoxysilane. Among them, 2-(3,4-epoxycyclohexyl)ethyltrimethoxysilane is preferable from the viewpoint of ease of a condensation reaction and hardness of a cured product.

The polyorganosiloxane compound as a condensate of the silane compound may be a condensate of the silane compound of the general formula (1) and another silane compound.

By reacting the above silane compound with water, the Si—OR¹ portion of the silane compound is hydrolyzed, the hydrolyzate is condensed to form a Si—O—Si linkage, and a condensate of a silane compound having an alicyclic epoxy group (a polyorganosiloxane compound) is generated.

From the viewpoint of increasing the hardness of a cured film (a hard coat layer), the weight average molecular weight of the polyorganosiloxane compound may be 500 or more. From the viewpoint of suppressing volatilization, the weight average molecular weight of the polyorganosiloxane compound may be 500 or more. On the other hand, when the molecular weight is excessively large, cloudiness may occur due to, for example, a decrease in compatibility with other components in the composition. Therefore, the weight average molecular weight of the polyorganosiloxane compound may be 20000 or less.

### <Polymerization Initiator>

Preferably, the hard coat composition contains a polymerization initiator in addition to the above-described curable resin components. The polymerization initiator may be a photopolymerization initiator. The acryl-based hard coat composition containing a compound having a (meth)acryloyl group as a curable resin component may contain a photoradical polymerization initiator that generates radicals by light. The siloxane-based hard coat composition containing a polyorganosiloxane compound having an epoxy group as a curable resin component may contain a photoacid generator (photocationic polymerization initiator) that generates an acid by light.

Examples of the photoradical polymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyldimethylketal, N,N,N′,N′-tetramethyl-4,4′-diaminobenzophenone, 1-(4-isopropylphenyl)-2-hydroxy-2-methylpropan-1-one, and other thioxanthone-based compounds.

Examples of the photoacid generator include onium salts in which an anion (a strong acid), such as antimony hexafluoride, boron tetrafluoride, phosphorus hexafluoride, phosphorus fluoroalkylfluoride, and gallium fluoroalkylfluoride, and a cation, such as sulfonium, ammonium, phosphonium, iodonium, and selenium, are combined; iron-allene complexes; silanol-metal chelate complexes; sulfonic acid derivatives such as disulfones, disulfonyldiazomethanes, disulfonylmethanes, sulfonylbenzoylmethanes, imidesulfonates and benzoinsulfonates; and organic halogen compounds.

### <Other Components Constituting Hard Coat Composition>

The hard coat composition for forming the hard coat layer may contain a solvent and various types of additive in addition to the curable resin component and the polymerization initiator. Examples of the additive include a leveling agent such as a fluorine-based or silicone-based leveling agent, a sensitizer, a reactive diluent, fine particles, a filler, a dispersant, a plasticizer, an ultraviolet absorber, a surfactant, an antioxidant, a colorant, and a viscosity modifier.

### <Formation of Hard Coat Layer>

The hard coat composition is applied onto the second principal surface 1B of the transparent resin film 1, the solvent is dried and removed as necessary, and then the resulting material is cured, whereby the hard coat layer 3 is formed. When the surface roughness of the transparent resin film 1 is different between the one and the other surfaces, the surface relatively larger in surface roughness (a surface having a larger Sa) is the second principal surface. When the transparent resin film 1 is produced by a solution method, the surface in contact with the support (the B surface) is the second principal surface, and the air surface (the A surface) is the first principal surface. By forming the hard coat layer 3 on the second principal surface 1B having a large surface roughness, the surface irregularities of the transparent resin film are filled and become inconspicuous, and the whiteness of the entire surface due to the surface irregularities is hardly visually recognized. As a result, the whitening unevenness is suppressed.

Examples of the method for applying the hard coat composition on the transparent resin film include roll coating such as bar coating, gravure coating, and comma coating, die coating such as slot die coating and fountain die coating, spin coating, spray coating, and dip coating. Before the application of a curable resin composition, the surface of the transparent resin film 1 may be subjected to surface treatment such as corona treatment or plasma treatment. In addition, an easily adhesive layer or the like may be provided on the surface of the transparent resin film 1.

When the hard coat composition is subjected to an active energy ray irradiation or heating, active species such as an acid and a radical are generated from the photopolymerization initiator, and the curable resin component of the hard coat composition is cured. From the viewpoint of curing reactivity, it is preferable that the curable resin composition contains a photopolymerization initiator and is cured by irradiation with an active energy ray. Examples of the active energy ray applied during photocuring include visible light rays, ultraviolet rays, infrared rays, X-rays, α-rays, β-rays, γ-rays and electron beams. An ultraviolet ray is preferable as the active energy ray due to its high curing reaction rate and excellent energy efficiency. The integral dose of the active energy rays is, for example, about 50 to 10000 mJ/cm², and may be set according to the type and the amount of the photocationic polymerization initiator, the thickness of the hard coat layer, and the like. The curing temperature is not particularly limited, and is typically 150 °C or lower.

The thickness of the hard coat layer 3 may be 1 to 50 μm, 3 μm or more, or 5 μm or more. There is a tendency that as the thickness of the hard coat layer is larger, the pencil hardness, and the scratch resistance are improved. On the other hand, when the thickness of the hard coat layer is excessively large, the bending resistance is deteriorated. Therefore, the thickness of the hard coat layer may be 40 μm or less, 30 μm or less, or 25 μm or less.

### [Hard Coat Film]

Although the thickness of the hard coat film 11 (the total thickness of the transparent resin film 1 and the hard coat layer 3) is not particularly limited, the thickness may be 30 μm or more, 40 μm or more, or 50 μm or more from the viewpoint of mechanical strength, and may be 200 μm or less, 100 μm or less, 80 μm or less, or 70 μm or less from the viewpoint of bendability.

The arithmetic mean roughness Sa of the hard coat layer-non-formed surface 1A of the hard coat film 11 (the first principal surface of the transparent resin film 1) is 1 nm or less, and may be 0.5 nm or less. The maximum height Sz of the hard coat layer-non-formed surface 1A may be 70 nm or less, 50 nm or less, 30 nm or less, or 10 nm or less. When the hard coat layer 3 is formed on the second principal surface 1B of the transparent resin film 1, the periodic surface shape such as undulation of the film may change, but Sa and Sz are determined from the contour curved surface from which the influence of the periodic surface shape is removed by filtering treatment, and thus Sa and Sz of the hard coat layer-non-formed surface 1A hardly change before and after the formation of the hard coat layer.

As described above, the hard coat layer 3 is formed on the second principal surface 1B having a relatively large surface roughness to fill the surface irregularities. Since the first principal surface 1A of the transparent resin film 1 has a small arithmetic mean roughness Sa, whitening unevenness is hardly visually recognized in the hard coat film 11.

The haze of the hard coat film may be 1% or less, 0.7% or less, or 0.5% or less. By using a resin having compatibility with a polyimide-based resin as the OTHER resin constituting the transparent resin film, the haze can be reduced. The polyimide-based resin and the OTHER resin are not necessarily completely compatible with each other, and may have a small microphase separation structure to such an extent that optical characteristics are not affected.

The total light transmittance of the hard coat film may be 90.3% or more, 90.5% or more, or 91.0% or more. Since the polyimide-based resin has a high refractive index and a high reflectance at the interface between the film and air and the interface between the film and the hard coat layer, the polyimide-based transparent resin film has a low total light transmittance. Blending of a polyimide-based resin and OTHER resin such as an acryl-based resin reduces the refractive index and reduces the reflectance at the interface, so that the total light transmittance is increased.

The yellowness index (YI) of the hard coat film may be −3.0 to 3.0 or less, −2.0 to 2.0, or −1.0 to 1.0. It is preferable that the absolute value of YI is small from the viewpoint of improving the visibility of a display and improving the color tone. Since transparent polyimide is slightly colored in yellow, the polyimide-based transparent resin film tends to have a large YI. By adopting a blend system of a polyimide-based resin and OTHER resin such as an acryl-based resin as the transparent resin film 1, coloring can be reduced and YI of the hard coat film 11 can be reduced.

The pencil hardness of the hard coat layer of the hard coat film may be 3H or more, 4H or more, or 5H or more. As the pencil hardness is higher, scratches and dents caused by external force are less likely to occur. The higher the pencil hardness is, the more excellent the scratch resistance is, and the film can be suitably used for applications such as a cover window disposed on the outermost surface of a display. When the hard coat film is used as a material for a foldable display, it is preferable that the hard coat film is superior in bending resistance and can be repeatedly bent 100,000 times or more at a radius of 1.5 mm.

The hard coat film of one or more embodiments of the present invention is superior in mechanical strength and bending resistance, high in transparency, and is superior in appearance characteristics with whitening unevenness hardly visually recognized, and thus can be suitably used as a cover window to be disposed on a surface of an image display panel.

### EXAMPLES

Hereinafter, one or more embodiments of the present invention will be described more specifically based on Examples and Comparative Examples, but the present invention is not limited to the following Examples. Hereinafter, a casting direction at the time of application is referred to as MD, and a direction perpendicular to MD is referred to as TD.

### [Preparation of Polyimide Resin]

Dimethylformamide (DMF) was added into a separable flask and stirred in a nitrogen atmosphere. Diamine and tetracarboxylic dianhydride were added thereto at the proportions (mol %) shown in Table 1, and the mixture was stirred for 5 to 10 hours under a nitrogen atmosphere to react, whereby a polyamic acid solution having a solid content concentration of 18 wt % was obtained.

To 100 g of the polyamic acid solution, 5.5 g of pyridine as an imidization catalyst was added, and completely dispersed, 8 g of acetic anhydride was then added, and the mixture was stirred at 90 °C for 3 hours. The solution was cooled to room temperature, and 100 g of2-propyl alcohol (IPA) was then added dropwise at a rate of 2 to 3 drops/sec while the solution was stirred, whereby a polyimide was precipitated. Further, 150 g of IPA was added, the mixture was stirred for about 30 minutes, and suction filtration was performed with a Kiriyama funnel. The obtained solid was washed with IPA, and then dried in a vacuum oven set at 120 °C for 12 hours, whereby polyimide resins 1 and 2 (PI 1, PI 2) were obtained.

In Table 1, the compounds are abbreviated as follows.

### <Tetracarboxylic Dianhydride>

CBDA: 1,2,3,4-cyclobutanetetracarboxylic acid dianhydride
6FDA: 2,2-bis(3,4-dicarboxyphenyl)-1,1,1,3,3,3-hexafluoropropane dianhydride
TAHNMBP: bis(1,3-dioxo-1,3-dihydroisobenzofuran-5-carboxylic acid)-2,2′,3,3′,5,5′-hexamethylbiphenyl-4,4′-diyl
ODPA: 4,4′-oxydiphthalic dianhydride

### <Diamine>

TFMB: 2,2′-bis(trifluoromethyl)benzidine
DDS: 3,3′-diaminodiphenylsulfone

TABLE 1

| | Acid dianhydride | | | | Diamine | |
|---|---|---|---|---|---|---|
| | CBDA | 6FDA | TAHMBP | ODPA | TFMB | DDS |
| PI 1 | 30 | 70 | — | — | 100 | — |
| PI 2 | 30 | — | 50 | 20 | 90 | 10 |

### [Production of Transparent Resin Film]

### <Film 1>

The polyimide resin 1 (PI 1) and a commercially available acryl-based resin (“PARAPET G” manufactured by Kuraray Co., Ltd.; methyl methacrylate/methyl acrylate (monomer ratio: 87/13) copolymer, glass transition temperature: 109 °C, acid value: 0.0 mmol/g; hereinafter referred to as “acryl-based resin” (Ac)) were dissolved in methylene chloride at a weight ratio of PI 1/Ac=55/45, and 5.6 parts by weight of a triazine-based ultraviolet absorber (“ADK STAB LA-31RG” manufactured by ADEKA CORPORATION) were added per 100 parts by mass in total of the resins, whereby a solution having a solid content of 15 wt % was prepared.

This solution was applied to a PET film (“Lumirror U40” manufactured by Toray Industries, Inc.; arithmetic mean roughness Sa of surface: 1 nm, maximum height Sz of surface: 41 nm) as a support using roll-to-roll type applying and drying equipment, and passed through a drying furnace whose temperature was set such that the temperature was raised stepwise from 30 °C to 45 °C, whereby a primary dried film having a residual solvent amount of 10 to 15 wt % was acquired. Hereinafter, the air surface at the time of preparing the primary dried film is referred to as “A surface”, and the surface in contact with the support is referred to as “B surface”.

The primary dried film was peeled off from the support (PET film), and the primary dried film was subjected to secondary drying by being passed through a drying furnace whose temperature was set such that the temperature was raised stepwise from 90 °C to 150 °C, whereby a film having a residual solvent amount of about 1 wt % and a thickness of 110 μm was obtained. The thickness of the film was measured using a contact type thickness meter.

The obtained film was subjected to fixed-end uniaxial stretching using a stretching machine equipped with a heating oven at a temperature of 215 °C and at a stretching ratio of 120% along TD as the stretching direction (TD length was 2.20 times that of the film before stretching), whereby a stretched film having a thickness of 50 μm was obtained.

### <Film 2>

A stretched film having a thickness of25 μm was produced using the same solution as that in the production of the Film 1. The application thickness was changed, the temperature range at the time of preparing the primary film was changed from 30 °C to 60 °C, the temperature range at the time of the secondary drying was changed from 80 °C to 130 °C, the temperature at the time of stretching was changed to 205 °C, and the stretch ratio was changed to 115%. Except for these changes, the same procedure as in the production of the Film 1 was carried out.

<Film 3>

100 parts by weight of the polyimide resin 2 (PI 2), 2.4 parts by weight of a triazine-based ultraviolet absorber (“Tinuvin 477” manufactured by BASF SE), and 0.0065 parts by weight of a bluing agent (“Plast Blue 8590” manufactured by ARIMOTO CHEMICAL Co., Ltd.) were dissolved in methylene chloride, whereby a solution having a solid content of7 wt % was prepared.

This solution was applied to a PET film (“Lumirror U40” manufactured by Toray Industries, Inc.) as a support using roll-to-roll type applying and drying equipment, and passed through a drying furnace set at a temperature such that the temperature was raised stepwise from 30 °C to 60 °C, whereby a primary dried film having a residual solvent amount of 5 to 15 wt % was acquired. The primary dried film was peeled off from the support, and the primary dried film was subjected to secondary drying by being passed through a drying furnace whose temperature was set such that the temperature was raised stepwise from 60 °C to 200 °C, whereby a film having a residual solvent amount of about 1 wt % and a thickness of 50 μm was obtained.

### [Evaluation of Transparent Resin Film]

The Films 1 to 3 were evaluated as follows.

### <Tensile Modulus>

Each film was cut into a strip shape having a width of 10 mm, and allowed to stand at 23 °C/55% RH for 1 day to adjust the humidity, and then a tensile test was performed under the following conditions using a tensile tester “AUTOGRAPH AGS-X” manufactured by Shimadzu Corporation to calculate a tensile modulus. The tensile test was performed in each of MD and TD.
Distance between chucks: 100 mm
Tensile speed: 20.0 mm/min
Measurement temperature: 23 °C

### <Arithmetic Mean Roughness Sa and Maximum Height Sz>

The three-dimensional surface shapes of the A surface and the B surface of a film were measured with a 50× objective lens using a white interference microscope (“ZYGO NEWVIEW 7300” manufactured by ZYGO). The measurement range was 0.28 mm×0.21 mm, and the entire measurement range was taken as a reference region. To eliminate the influence of the periodic surface shape, such as the undulation, of the entire film, the following filtering conditions were applied to calculate the arithmetic mean roughness Sa and the maximum height Sz. The maximum height Sz is a value denoted as PV in the software equipped in the device.
Filter: High Pass
Filter Type: Gauss Spline
Filter Low Wavelength: 30.00000 μm
Filter High Wavelength: not set

The materials and thicknesses of the Films 1 to 3 and the evaluation results are shown in Table 2.

TABLE 2

| | | 1 | 2 | 3 |
|---|---|---|---|---|
| Material | | PI 1/Ac | PI 1/Ac | PI 2 |
| Thickness (μm) | | 50 | 25 | 50 |
| Sa (nm) | A surface | 0 | 0 | 1 |
| | B surface | 2 | 2 | 2 |
| Sz (nm) | A surface | 5 | 5 | 38 |
| | B surface | 77 | 45 | 75 |
| Tensile | MD | 3.8 | 3.4 | ND |
| modulus | TD | 5.4 | 5.3 | |
| (GPa) | | | | |

### [Preparation of Hard Coat Composition]

### <Preparation of Acryl-Based Hard Coat Composition>

To 100 parts by weight of dipentaerythritol hexaacrylate (“ARONIX M-403” manufactured by TOAGOSEI CO., LTD.), 2 parts by weight of a photoradical polymerization initiator (“Omnirad 184” manufactured by IGM Resins) and 0.25 parts by weight of a polyether-modified silicone-based leveling agent (“BYK-300” manufactured by BYK) were added, and propylene glycol monomethyl ether was added as a diluent solvent, whereby an acryl-based hard coat composition having a solid content of 50 wt % was obtained.

### <Siloxane-Based Hard Coat Composition>

A reaction vessel equipped with a thermometer, a stirrer, and a reflux condenser was charged with 66.5 g (270 mmol) of 2-(3,4-epoxycyclohexyl)ethyltrimethoxysilane (“SILQUESTA-186” manufactured by Momentive Performance Materials Inc.) and 16.5 g of 1-methoxy-2-propanol (PGME), and the mixture was homogeneously stirred. To the mixed solution, a solution obtained by dissolving 0.039 g (0.405 mmol) of magnesium chloride as a catalyst in a mixed solution of9.7 g (539 mmol) of water and 5.8 g of methanol was added dropwise over 5 minutes, and the mixture was stirred to be homogeneous. Thereafter, the solution was heated to 80 °C, and a polycondensation reaction was performed for 6 hours with stirring. After completion of the reaction, the solvent and water were distilled off by a rotary evaporator, whereby a condensate of a silane compound (polyorganosiloxane compound) was obtained.

The polystyrene-equivalent weight-average molecular weight measured by GPC apparatus “HLC-8220GPC” (column: TSKgel GMH_{XL}×2 columns, TSKgel G3000H_{XL}, TSKgel G2000H_{XL}) manufactured by TOSOH CORPORATION was 3000. The residual rate of epoxy groups calculated from a ¹H-NMR spectrum measured using deuterated acetone as a solvent with 400 MHz-NMR manufactured by Bruker was 95% or more.

To 100 parts by weight of the polyorganosiloxane compound above, 2 parts by weight of a sulfonium-based photoacid generator (“CPI-101A” manufactured by San-Apro Ltd.) and 0.25 parts by weight of a polyether-modified silicone-based leveling agent (“BYK-300” manufactured by BYK) was added, and propylene glycol monomethyl ether was added as a diluent solvent, whereby a siloxane-based hard coat composition having a solid content of 50 wt % was obtained.

### [Production of Hard Coat Film]

### Example 1

The acryl-based hard coat composition was applied onto the B surface of the Film 1 such that the dried thickness was 5 μm, and the solvent was removed at 120 °C. Thereafter, the hard coat resin composition was cured by irradiation with ultraviolet rays in a nitrogen atmosphere using a high-pressure mercury lamp such that the integral dose was 1950 mJ/cm², whereby a hard coat film including the acryl-based hard coat layer having a thickness of 5 μm was obtained. Herein, the thickness of the hard coat layer is a difference between the thickness of the hard coat film and the thickness of the film before forming the hard coat layer each measured by using a contact type thickness meter.

### Example 2

The siloxane-based hard coat composition was applied onto the B surface of the Film 1 with a coater such that the dried thickness was 20 μm, and the solvent was removed at 120 °C. Thereafter, the hard coat resin composition was cured by irradiation with ultraviolet rays in an air atmosphere using a high-pressure mercury lamp such that the integral dose was 1950 mJ/cm², whereby a hard coat film including the siloxane-based hard coat layer having a thickness of 20 μm was obtained.

### Comparative Examples 1 and 2

Hard coat films were obtained in the same manner as in Examples 1 and 2 except that the surface on which a hard coat layer was formed (the surface to which a hard coat composition was applied) was changed to the A surface of the Film 1.

### Comparative Example 3

A hard coat film was obtained by forming an acryl-based hard coat layer having a thickness of 5 μm in the same manner as in Comparative Example 1 on the A surface of the Film 3 instead of the Film 1.

### [Evaluation of Hard Coat Film]

### <Total Light Transmittance and Haze>

The total light transmittance and the haze were measured by the methods described in JIS K 7361-1:1999 and JIS K 7136:2000 using a haze meter “HZ-V3” manufactured by Suga Test Instruments Co., Ltd. A D65 light source was used for the measurement.

### <Pencil Hardness>

The pencil hardness of the hard coat layer surface was evaluated with a load of 750 g according to JIS K5600. A test of scratching (moving a pencil) along MD and a test of scratching along TD were performed, and the higher hardness was taken as the pencil hardness of the hard coat film.

### <Repeated Bending Test>

A hard coat film was cut into a rectangle of 20 mm×150 mm with the long sides being along TD, whereby a sample for evaluation was prepared. The sample for evaluation was mounted in a U-shaped bending durability tester DMLHB manufactured by YUASA SYSTEM Co., Ltd., and a bending test was repeated 100,000 times at a bending radius of 1.5 mm, a bending angle of 180°, and a speed of 1 time/second with MD as a bending axis such that the hard coat layer was on the inner side. The test was performed in a thermo-hygrostat set at a temperature of23 °C and a humidity of 55%. In the hard coat films of Examples 1 and 2 and Comparative Examples 1 to 3, neither cracking nor fractured was found after the test, and the hard coat films exhibited good bending resistance.

### <Appearance (Whitening Unevenness)>

The hard coat film was cut into a rectangle of 300 mm×210 mm with the long sides being along MD, and four sides of the cut hard coat film was fixed to a frame made of corrugated plastic such that the cut hard coat film was flatted. In a dark room, light of a three-wavelength fluorescent lamp was applied to the hard coat film, and the transmitted light was visually observed. The incident angle of the transmitted light was adjusted in a range of 60 to 890 with respect to the normal line of the film plane. Specifically, the hard coat film was disposed between the fluorescent lamp and an observer, the hard coat film was inclined in a range of 60 to 890 with MD or TD as an inclination axis, and light of the fluorescent lamp passing through the hard coat film was observed. When white portions and non-white portions were distributed and visually recognized as unevenness in the plane of the hard coat film at any angle of 60 to 89°, it was determined that whitening unevenness was “observed”. When unevenness was not visually recognized in both the case where the hard coat film was inclined in the range of 60 to 890 with MD as the inclination axis and the case where the hard coat film was inclined in the range of 60 to 89° with TD as the inclination axis, it was determined that whitening unevenness was “absent.”

The compositions and evaluation results of the hard coat films of Examples and Comparative Examples are shown in Table 3. In Table 3, the evaluation results (presence or absence of whitening unevenness) of the Films 1 and 2 provided with no hard coat layer are shown as Reference Examples 1 and 2. In Reference Examples 1 and 2, the surface shape of the surface provided with no hard coat layer (HC-non-formed surface) is described in the form of the roughness (nm) of the A surface/the roughness (nm) of the B surface.

TABLE 3

| | | | Example | Example | Comparative | Comparative | Comparative | Reference | Reference |
|---|---|---|---|---|---|---|---|---|---|
| | | | 1 | 2 | Example 1 | Example 2 | Example 3 | Example 1 | Example 2 |
| Transparent | | | 1 | | | | 3 | 1 | 2 |
| resin film | Material | | PI 1/Ac | | | | PI 2 | PI 1/Ac | PI 1/Ac |
| | Thickness (μm) | | 50 | | | | 50 | 50 | 25 |
| Hard coat | Formed surface | | Surface B | Surface B | Surface A | Surface A | Surface A | | |
| layer | Material | | Acryl | Siloxane | Acryl | Siloxane | Acryl | | |
| | Thickness(μm) | | 5 | 10 | 5 | 10 | 5 | | |
| Hard coat | HC-non- | Sa (nm) | 0 | 0 | 2 | 2 | 2 | 0/2 | 0/2 |
| film | formed surface | Sz (nm) | 5 | 5 | 77 | 77 | 75 | 5/77 | 5/45 |
| | shape | | | | | | | | |

| | | | | | | | |
|---|---|---|---|---|---|---|---|
| Pencil hardness | 4H | 5H | 4H | 5H | ND | ND | ND |
| Whitening unevenness | Absent | Absent | Observed | Observed | Observed | Observed | Observed |
| Total light transmittance(%) | 91.6 | 91.6 | 91.6 | 91.6 | 88.9 | ND | ND |
| Haze(%) | 0.3 | 0.3 | 0.3 | 0.3 | 1.1 | | |

No whitening unevenness was observed in the Film 2 having a thickness of 25 μm (Reference Example 2), whereas whitening unevenness was observed in the Film 1 having a thickness of 50 μm (Reference Example 1). These results show that whitening unevenness is likely to occur when the thickness of a film is large.

In Comparative Examples 1 and 2, in which a hard coat layer was formed on the A surface (Sa=0 nm, Sz=5 nm) of the Film 1, whitening unevenness was observed as in the Film 1, and also in Comparative Example 3, in which a hard coat layer was formed on the A surface (Sa=1 nm, Sz=38 nm) of the Film 3, whitening unevenness was observed. On the other hand, in Examples 1 and 2, in which a hard coat layer was formed on the B surface (Sa=2 nm, Sz=77 nm) of the Film 1, whitening unevenness was not observed.

From these results, it is considered that in the hard coat films of Examples 1 and 2, irregularities on the film surface were filled by forming the hard coat layer on the B surface having a relatively large surface roughness, and the A surface having a relatively small surface roughness (Sa=0 nm, Sz=5 nm) was exposed, so that the whitening unevenness was eliminated.

The hard coat films of Examples 1 and 2, in which a hard coat layer was formed on the surface of a blended resin film of a polyimide-based resin and an acryl-based resin, were higher in total light transmittance and superior in transparency as compared with Comparative Example 3, in which a hard coat layer was formed on the surface of the Film 3 of the polyimide-based resin alone, in addition to the fact that whitening unevenness was eliminated. In addition, the hard coat films of Examples 1 and 2 have high pencil hardness and superior bending resistance, and therefore can be suitably used as a cover window of a foldable display.

### DESCRIPTION OF REFERENCE SIGNS

1 transparent resin film
   1A first principal surface (hard coat layer-non-formed surface)
   1B second principal surface (hard coat layer-formed surface)
3 hard coat layer
11 hard coat film

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A hard coat film comprising:
a transparent resin film having a first principal surface and a second principal surface; and
a hard coat layer disposed on the second principal surface of the transparent resin film,
wherein:
the transparent resin film has a thickness of 26 μm or more and comprises a polyimide-based resin and a solvent-soluble resin other than the polyimide-based resin,
no hard coat layer is provided on the first principal surface of the transparent resin film, and
an arithmetic mean roughness Sa of the first principal surface of the transparent resin film is 1 nm or less.

2. The hard coat film according to claim 1, wherein in the transparent resin film, an arithmetic mean roughness Sa of the second principal surface is larger than the arithmetic mean roughness Sa of the first principal surface.

3. The hard coat film according to claim 1, wherein an arithmetic mean roughness Sa of the second principal surface of the transparent resin film is 1.5 nm or more.

4. The hard coat film according to claim 1, wherein a maximum height Sz of the first principal surface of the transparent resin film is 70 nm or less.

5. The hard coat film according to claim 4, wherein in the transparent resin film, a maximum height Sz of the second principal surface is larger than a maximum height Sz of the first principal surface.

6. The hard coat film according to claim 1, wherein the solvent-soluble resin is an acryl-based resin.

7. The hard coat film according to claim 6, wherein the acryl-based resin contains methyl methacrylate as a main component.

8. The hard coat film according to claim 1, wherein:
the polyimide-based resin is a polyimide comprising a structure derived from a tetracarboxylic dianhydride and a structure derived from a diamine,
a fluorine-containing aromatic tetracarboxylic dianhydride and an alicyclic tetracarboxylic dianhydride are comprised as the tetracarboxylic dianhydride, and
a fluorine-containing diamine is comprised as the diamine.

9. The hard coat film according to claim 1, wherein the transparent resin film is a stretched film.

10. The hard coat film according to claim 1, wherein the hard coat layer is an acryl-based hard coat layer.

11. The hard coat film according to claim 1, wherein the hard coat layer is a siloxane-based hard coat layer.

12. The hard coat film according to claim 1, wherein the hard coat layer has a thickness of 1 to 50 μm.

13. A method for producing the hard coat film set forth in claim 1, the method comprising:
forming a transparent resin film by applying a resin solution in which the polyimide-based resin and the solvent-soluble resin other than the polyimide-based resin are dissolved in a solvent onto a support, and thereafter heating the solution on the support to dry and remove the solvent;
peeling off the transparent resin film from the support; and
forming a hard coat layer on a surface of the transparent resin film from where the support is peeled off.

14. The method for producing the hard coat film according to claim 13, wherein a surface of the support to which the resin solution is applied has an arithmetic mean roughness Sa of0.5 nm or more.

15. The method for producing the hard coat film according to claim 13, wherein a surface of the support to which the resin solution is applied has a maximum height Sz of 10 nm or more.

16. The method for producing the hard coat film according to claim 13, wherein the support is a plastic film.

17. A display including the hard coat film according to claim 1.
